(19) United States
(12) Patent Application Publication
(10) Pub. No.: US 2020/0355595 A1
(43) Pub. Date: Nov. 12, 2020

(54) METHOD AND DEVICE FOR PRODUCING SEED-LIKE SOLID PARTICLES AND COMPUTER PROGRAM

(71) Applicant: K+S AKTIENGESELLSCHAFT, Kassel (DE)

(72) Inventors: Paul MEISSNER, Graz (AT); David SCHERR, Huenfeld (DE); Maik KLOTZBACH, Obersuhl (DE); Guido BAUCKE, Schenklengsfeld OT Wippershain (DE)

(73) Assignee: K+S AKTIENGESELLSCHAFT, Kassel (DE)

(21) Appl. No.: 16/762,383

(22) PCT Filed: Nov. 2, 2018
(86) PCT No.: PCT/DE2018/000322

§ 371 Date: May 7, 2020

(30) Foreign Application Priority Data
Nov. 7, 2017 (DE) 102017010271.6

(51) Int. Cl. G01N 15/02; B01J 2/14

(52) U.S. Cl. CPC G01N 15/0227; B01J 2/14

(57) ABSTRACT

The invention relates to a method for producing seed-like solid particles from at least one, but typically two starting substances, wherein the produced particles are optically detected by means of an optical detection system, wherein data of the produced particles detected optically by the optical detection system is provided, and at least one, but typically two parameters of the produced particles are determined from the optically detected data of the produced particles, wherein at least one, but typically two optically determined parameters automatically synergetically influence the production process of further particles on the basis of the optically detected data of the produced particles. The invention further relates to a device for carrying out the method and a computer program for carrying out the method.

The invention relates to a method for producing granular solid particles from at least one starting substance, wherein the particles produced are optically captured using an optical capturing system, wherein data of the produced particles that are captured optically by the optical capturing system are provided, and at least one parametric quantity of the produced particles is determined from the optically captured data of the produced particles. The invention additionally relates to a device for carrying out the method and to a computer program for carrying out the method.

Granular solid particles, which are also referred to here as “particles” in short, are available in a wide variety of designs, for example in the form of pellets, granules, briquettes or similar bulk material. Arbitrary shapes and sizes are included in the term particles, although a pulverulent consistency is not included anymore.

When producing the particles, it is generally desirable to adhere to certain shape and size specifications. In many production processes, however, exact compliance with these specifications cannot be guaranteed. Tolerances are therefore also permitted, wherein the tolerances should not be too large so as to ensure a constant product quality of the particles. There are already proposals for optical sorting of such particles, for example in U.S. Pat. No. 8,833,566 B2. The rejects generated during production are automatically sorted out here.

The invention is based on the object of making the production process of such granular solid particles more efficient and with less waste.

In a method of the type mentioned in the introductory part, this object is achieved in that at least one parameter of the production process of further particles is automatically influenced on the basis of the at least one parametric quantity ascertained from the optically captured data of the particles produced, wherein the parametric quantity ascertained is the grain size or grain size distribution of the particles produced or a variable ascertained therefrom. The invention has the advantage that, based on the optical capturing of the particles produced, there is an active intervention in the production process and this can be adapted in such a way that waste is minimized. This is a complete departure from the proposals in the prior art, as described, for example, in U.S. Pat. No. 8,833,566 B2, in which the variance in the production process and the waste generated thereby are simply accepted.

The present invention therefore not only has a commercial benefit for the user, but also benefits the protection of natural resources and environmental protection.

The invention can be used in various production processes in which granular solid particles are produced, for example in the production of fertilizer, in the production of iron ore pellets, in the production of other spreading materials, in the production of dry feed for animals.

According to the invention, provision is made for the at least one parametric quantity ascertained from the optically captured data of the particles produced to be the grain size or grain size distribution of the particles produced or a variable ascertained therefrom. In this way, the grain size or, at least over the grain size distribution, a statistical median value of the grain size can be checked using the method according to the invention and the production of further particles can be adjusted accordingly. The d₅₀ value can be determined, for example, as the grain size distribution. Said value indicates a median diameter of the particles, for example in a way such that the diameter of the particles is indicated at 50% of the cumulative distribution. In other words, the d₅₀ value refers to the particles which are at least as large as the diameter based on the d₅₀ value, that is to say 50% of the particles are smaller than the stated value. One or more further variables can also be determined from the optically captured data as the ascertained parametric quantity, for example the number of particles, the volume, represented as a derived diameter, for example as a Feret, area-equivalent or hydraulic diameter or as parametric quantities that describe the shape of the particles with regard to “roundness” and “uniformity.”

According to an advantageous development of the invention, provision is made for a target value to be specified for the at least one parametric quantity ascertained from the optically captured data of the particles produced and for the method to be carried out in the sense of a feedback control such that, by influencing the at least one parameter of the production process, the further particles are produced with a parametric quantity that substantially corresponds to the target value. In this way, feedback control to the target value can be carried out. This has the advantage that the method can be implemented, for example, by feedback control engineering methods, for example by using feedback controller types known in feedback control engineering.

According to an advantageous development of the invention, provision is made for the feedback control to be carried out at least by means of a primary feedback control parameter, wherein the primary feedback control parameter is the grain size or grain size distribution of the particles produced or a variable ascertained therefrom. In this way, the grain size of the particles produced can be guided, at least on average, substantially to the desired target value. Tolerances that still occur can be minimized.

According to an advantageous development of the invention, provision is made for the feedback control to be carried out at least by means of a primary feedback control parameter and a secondary feedback control parameter, wherein the primary feedback control parameter has priority over the secondary feedback control parameter. This has the advantage that, by introducing a further feedback control parameter, that is to say the secondary feedback control parameter, the feedback control can react even more flexibly to particular situations in the production of the particles. For example, on the basis of the secondary feedback control parameter, a rapid or abrupt change in the parameter of the production process that is influenced by the feedback control can be effected.

According to an advantageous development of the invention, provision is made for the secondary feedback control parameter to be the number of particles and/or the temporal change in the number of particles per unit time or a variable ascertained therefrom. This has the advantage that the particles produced are optimized not only with regard to the grain size or grain size distribution, but also with regard to the number of particles and/or their change over time. Experiments have shown that in some cases, by evaluating the number of particles and/or changing them over time, particular undesirable tendencies in the production process of the particles can be recognized more quickly than by merely assessing the grain size or grain size distribution.

According to an advantageous development of the invention, provision is made for the particles to be produced from at least a first and a second starting substance, which differs from the first, and for the at least one parameter of the production process that is automatically influenced to be the mixing ratio between the first and the second starting substance or the addition of the first and/or the second starting substance to the production process of the particles. By mixing the two starting substances, the particles produced can also be improved in terms of their physical properties such as hardness on the basis of a chemical interaction. In this way, fertilizers in particular can be efficiently produced. For example, the first starting substance can be a pulverulent substance, the second starting substance can be a liquid substance.

The optical capturing system can have one or more optical sensors, for example in the form of a line scan camera or a multidimensional photo sensor, for example in the form of an area scan camera, with which two-dimensional image information can be provided.

According to an advantageous development of the invention, provision is made for the particles produced to be optically captured by means of at least one camera of the optical capturing system. This allows very precise and high-resolution optical capturing of the particles. The images produced by the camera can advantageously be subjected to subsequent image processing, which in particular makes it possible to identify individual particles in the recorded image and to differentiate them from other particles.

According to an advantageous development of the invention, provision is made for the particles produced to be illuminated by a light source of the optical capturing system during optical capturing using the incident-light method. As a result, the optical capturing system can be implemented simply and reliably. The parametric quantity can be reliably determined from the optically captured data. The advantage of this type of illumination is full homogeneous illumination of the region to be analyzed and—above all—the minimization of temporally changing extraneous light influences. The illumination can be implemented with halogen light sources or—to save energy—with LEDs. When using LEDs, it is advantageous if an LED driver is connected upstream that provides a frequency of at least 500 Hz, so that no flickering occurs during the recordings. The supporting surface or background that is concomitantly filmed can likewise be adapted. In order to create maximum contrast to the, for example, grayish/white particles produced, a black plate made of PTFE, for example, can be used as a supporting surface or background. Another advantage of PTFE is that no caking that could falsify the recordings forms.

The abovementioned object is additionally achieved by a device for producing granular solid particles from at least one starting substance, having at least one first starting substance feed device, at least one processing device for processing the at least one starting substance, and at least one optical capturing system which is configured for optically capturing the particles emerging from the processing device and having at least one control device, which is configured to control at least one parameter of the production process at least in dependence on at least one parametric quantity ascertained by the optical capturing system, wherein the device is configured to carry out a method of the type explained above.

The advantages explained above can also be realized hereby. The first starting substance feed device serves to feed the first starting substance to the processing device. The fed first starting substance is then processed in the processing device. The processing device generates the particles produced. The entire process can be controlled by the control device, for example by virtue of the control device executing a computer program with which the method according to the invention is carried out. For this purpose, the control device can have a computer, for example a personal computer (PC), a microprocessor or a microcontroller.

According to an advantageous development of the invention, provision is made for the device to have at least one second starting substance feed device for a second starting substance, wherein the second starting substance feed device has a valve arrangement with a plurality of switchable valves arranged in parallel branches, by means of which valves the second starting substance is able to be fed to the processing device with varying addition quantities depending on the valve actuation of the valves. The second starting substance feed device can be used to feed the second starting substance to the processing device. The plurality of switchable valves arranged in parallel branches have the advantage that the amount of the second starting substance dispensed can be easily adjusted with sufficient fineness in a feedback-controlled manner. The apparatus required for this is low; simple switchable valves such as pneumatic valves, solenoid valves or piezo valves can be used.

According to an advantageous development of the invention, provision is made for the first starting substance feed device to have a valve arrangement with a plurality of switchable valves arranged in parallel branches, by means of which valves the first starting substance is able to be fed to the processing device with varying addition quantities depending on the valve actuation of the valves. As a result, the amount of the first starting substance fed can be set in a simple manner.

According to an advantageous development of the invention, provision is made for the starting substances, for example Kieserit-M (ground ESTA Kieserit) and Kieserit-E (non-ground fine ESTA Kieserit), to be already captured by means of an optical measurement of the grain size or grain size distribution (as described above) before they are fed to the processing device. Since a later spraying of the first starting substance with a second starting substance (liquid) can take place, it is possible to calculate the specific surface of the starting materials and therefrom the amount of liquid required for spraying at a desired identical target grain size by determining the grain sizes or grain size distributions and to adjust the amount of liquid to be fed by way of valve feedback control.

The abovementioned object is additionally achieved by a computer program with program code means, configured to carry out the method of the type explained above, when the computer program is executed on a computer. The computer program can, for example, be executed on a computer of the device explained above or by the control device thereof.

The invention will be explained in more detail below on the basis of exemplary embodiments using drawings.

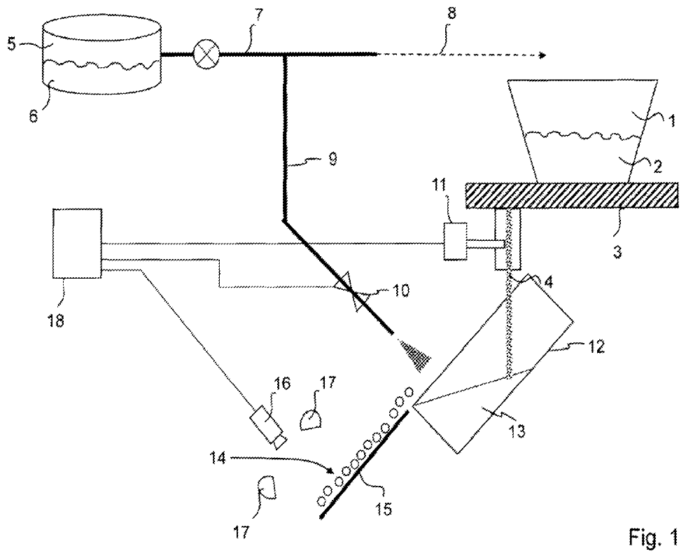

In the drawings FIG. 1 shows a schematic illustration of a device for producing granular solid particles and

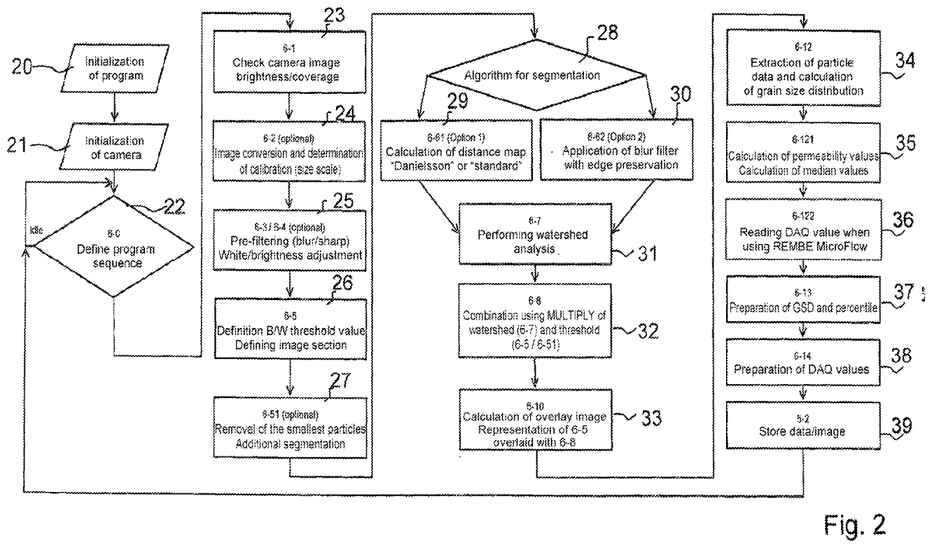

FIG. 2 is a flowchart of a sequence during the optical data capturing and

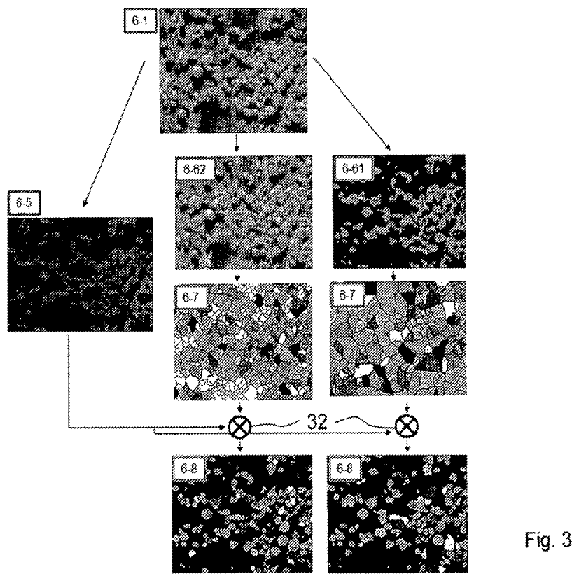

FIG. 3 shows image data generated in the course of the sequence of FIG. 2 and

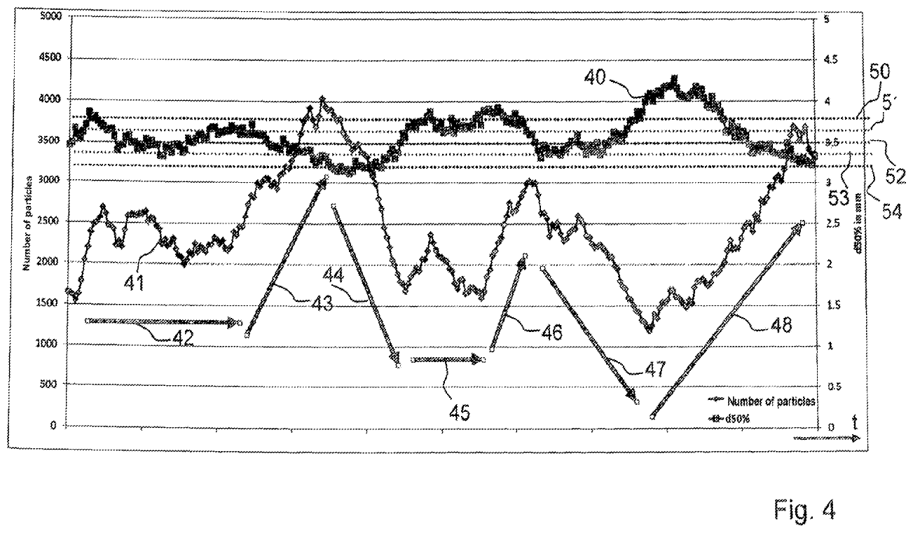

FIG. 4 shows a process of the feedback control of the at least one parameter of the production process in a time diagram.

The device illustrated in FIG. 1 has a first starting substance feed device 1, 3. The latter includes a storage container 1, in which a supply of a first starting substance 2 of the production process is present, and a conveyor device 3. It is assumed that the first substance 2 has a pulverulent consistency. In order to further convey this pulverulent first starting substance 2, the conveyor device 3—for example, a screw—is arranged below the storage container 1. The conveyor device 3 conveys a feed stream 4 of the first starting substance 2 to a processing device 12. The processing device 12 can be embodied, for example, as a granulating or pelletizing plate, which is rotated. The rotational movement results in a build-up agglomeration of the fed first starting substance 2, in combination with an additionally fed second starting substance 6. The resulting granular solid particles 14 are fed to a further use via an output device 15, for example a chute or a conveyor belt.

The device has a second starting substance feed device 5, 7, 9. The latter includes a second storage container 5, in which the, for example liquid, second starting substance 6 is present, and lines 7, 9. The second starting substance 6 is fed to the processing device 12 via the lines 7, 9, for example by spraying the second starting substance 6 from the end of the line 9. The second starting substance 6 can be fed to a further application via a further line 8, for example for introducing it into a mixer.

The device furthermore has a control device 18, for example in the form of an electronic control device. The electronic control device can be implemented substantially by a computer, possibly supplemented by corresponding hardware expansions for interfaces to the components that will be explained below.

The control device 18 is connected to a flow meter 11. The mass flow of the feed stream 4 can be measured by way of the flow meter 11. The control device 18 is additionally connected to an optical capturing system 16, 17.

The optical capturing system has a camera 16, which is directed at the particles 14 to record them and to output corresponding images to the control device 18. In order to improve the quality of the recordings of the camera 16, the particles 14 are illuminated by light sources 17.

A valve arrangement 10 through which the amount of the second starting substance 6 that is sprayed out of the line 9 can be influenced is furthermore arranged in the line 9. The valve arrangement 10 can, for example, have a plurality of switchable valves arranged in parallel branches, so that the discharge of the second starting substance 6 can be switched off completely or can be set to different strengths by optionally switching one or more of said valves on or off.

The control device 18 reads the data that are output by the flow meter 11 and the image data that are output by the camera 16 and processes them. As part of this processing, the control device 18 generates control data for the valve arrangement 10. The at least one parameter of the production process of further particles 14 is influenced by way of the valve arrangement 10 and the corresponding control data, and the previously explained feedback control process is implemented in this way, which will be explained in more detail below with reference to the further figures.

FIG. 2 shows the processing of the images of the camera 16 in the control device 18, for example in the form of a computer program, wherein the at least one parametric quantity of the particles 14 produced is determined from the optically captured data of the particles 14 produced. This parametric quantity is then used for further feedback control.

The computer program is initialized in a step 20. In a subsequent step 21, the camera 16 is initialized. The program sequence is determined in a step 22. This additionally includes a waiting loop, which is carried out, for example, when it is necessary to wait for new output data during the image processing.

In a step 23, which follows step 22, the camera image is first checked with respect to brightness and coverage. This is an initial plausibility check of the image data. An image conversion and a calibration of the optical capturing system are then carried out in step 24, that is to say the size scale is determined. This step 24 needs to be carried out once to set up the optical capturing system. In a subsequent step 25, further image adjustments can be made, for example pre-filtering (blur/sharp). This step is optional. Furthermore, a white/brightness adjustment should be carried out once. In a subsequent step 26, a black-and-white threshold value is defined. An image section that is to be processed is defined. In a subsequent step 27, the smallest particles in the image data are filtered out. Additional segmentation of the image data can take place. Step 27 is likewise optional.

An algorithm is then carried out in step 28 for segmentation. Segmentation means that the individual particles are automatically detected in the camera image by the algorithm mentioned, even if they partially overlap during the image recording of the camera 16. In step 29, for example, the segmentation can be carried out by calculating a distance map. The calculation can be carried out according to Danielsson's method or the standard method. Alternatively, segmentation can be carried out in step 30 using a blur filter with edge preservation. It is also possible to carry out both segmentation algorithms and then to overlay or combine the data generated in the process.

In a subsequent step 31, a watershed analysis is carried out. The data generated in the process are combined in a subsequent step 32 with the data generated in step 26 or in step 27, for example by means of pixel-wise multiplication. In a subsequent step 33, an overlay image is created in which the image data generated in step 26 are overlaid with the image data generated in step 32. This step serves merely to better illustrate the process result and is usually deactivated to optimize the computing time. In a subsequent step 34, parametric quantities of the particles 14 are determined from the image data now generated, for example the grain size or grain size distribution thereof, in particular the d₅₀ value or another suitable percentile of the grain distribution.

In a subsequent step 35, further permeability values and/or average values can be determined. In a subsequent step 36, the data of the feed stream 4 are read from the optionally usable flow meter 11.

In subsequent steps 37 and 38, the data obtained in this way are prepared. The generated data and the images of the camera 16 can be stored in a step 39. The method then continues with step 22.

FIG. 3 shows exemplary image data before and after being processed based on the numerical identifiers specified in some of the steps in FIG. 2.

The multiplication symbols symbolize the combination of the data in step 32. As can be seen, the segmentation enables the individual captured particles to be separated very well in the image data, with the result that particles arranged very close together in the image are not recognized as a single large particle, but can instead be automatically recognized and evaluated as individual particles.

The data obtained in steps 34 and 35, which are based on the optically captured data of the particles produced, are now used to influence at least one parameter of the production process, that is to say in this case to control the valves of the valve arrangement 10. This can be done for example in the manner shown in FIG. 4.

FIG. 4 shows the d₅₀ values of the particles 14 in the curve profile 40 and the number of particles per unit time in the curve profile 41. The particles 14 produced are to be produced with a particle size of, for example, 3.5 mm (d₅₀ value). This is thus a target value for the feedback control. Since this target value cannot be adhered to exactly during the production process, tolerances are permitted. Based on this, specific threshold values 50, 51, 53, 54 with respect to the d₅₀ values (curve profile 40) are defined for carrying out the feedback control and in particular for controlling the valve arrangement 10. Control patterns for the valves of the valve arrangement are ascertained depending on whether the d₅₀ value exceeds or falls below specific threshold values.

If, for example, Kieserit-M or Kieserit-E or a mixture of the two is used as the first starting substance in the production process and an MgSO₄ solution is used as the second starting substance, a larger amount of the second starting substance 6 must be fed in during the feedback control process if the d₅₀ value is too low than is required if the d₅₀ value is in the desired range. If the d₅₀ value increases too much, the feed of the second starting substance 6 must be reduced or be switched off completely.

In the sequence according to FIG. 4, the desired range is the range between the threshold values 51 and 53. If the d₅₀ value is in this range, normal operation, as it is known, is taking place. In this case, an amount of the second starting substance 6 that is assigned to normal operation is discharged via the line 9 and the valve arrangement 10. If the threshold value 51 is exceeded, the feed of the second starting substance 6 is reduced for a first time. If the threshold value 50 is exceeded, the feed of the second starting substance 6 is reduced even more or the feed is switched off. If the value falls below the threshold value 53, the fed amount of the second starting substance 6 is increased. If the value falls below the threshold value 54, the fed amount of the second starting substance 6 is increased still further.

A further improvement in the feedback control can be achieved by taking the gradient of the curve profile 41 into account. If the curve profile 41 has only relatively short periods of time with increases and decreases in the curve profile or only slight gradients, as for example in the periods 42 and 45, the feedback control based on the primary feedback control parameter d₅₀ is sufficient. In periods 43, 46 and 48, however, additional intervention is required. This takes place in the form of a positive boost in a way such that a considerable increase in the discharged amount of the second starting substance 6 is set via the valve arrangement 10. A negative boost takes place in the periods 44, 47, that is to say in these periods, the discharged second starting substance is reduced considerably. The time periods for such a negative or positive boost can be limited in the feedback control to a predetermined time limit value, for example to 20 seconds.

The d₅₀ values here form the primary feedback control parameter, and the number of particles forms the secondary feedback control parameter. If the corresponding threshold value criteria of the threshold values 50 to 54 occur, the primary feedback control parameter can always overwrite the secondary feedback control parameter, that is to say the primary feedback control parameter has priority in the feedback control in such cases.

1. A method for producing granular solid particles, the method comprising:
producing granular solid particles from at least one starting substance by a production process;
optically capturing the produced granular solid particles using an optical capturing system to produce data;
determining at least one parametric quantity of the produced granular solid particles from the data; and
automatically influencing at least one parameter of the production process on the basis of the at least one parametric quantity,
wherein the at least one parametric quantity is a grain size or a grain size distribution of the produced granular solid particles or a variable ascertained therefrom.

2. The method of claim 1, further comprising:
specifying a target value for the at least one parametric quantity; and
producing additional particles by a feedback control of the production process after the influencing, wherein the additional particles have a parametric quantity that substantially corresponds to the target value.

3. The method of claim 2, wherein the feedback control is carried out at least by means of a primary feedback control parameter, and
wherein the primary feedback control parameter is the grain size or the grain size distribution of the produced granular solid particles or a variable ascertained therefrom.

4. The method of claim 2, wherein the feedback control is carried out at least by means of a primary feedback control parameter and a secondary feedback control parameter, wherein the primary feedback control parameter has priority over the secondary feedback control parameter.

5. The method of claim 4, wherein the secondary feedback control parameter is at least one selected from the group consisting of a number of particles, a temporal change in a number of particles per unit time, and a variable ascertained therefrom.

6. The method of claim 1, wherein the produced granular solid particles are produced from at least a first and a second starting substance, which differs from the first, and
wherein the at least one parameter of the production process is selected from the group consisting of a mixing ratio between the first and the second starting substance, an addition of the first starting substance to the production process, and an addition of the second starting substance to the production process.

7. The method of claim 1, wherein the produced granular solid particles are optically captured by at least one camera of the optical capturing system.

8. The method of claim 1, wherein the produced granular solid particles are illuminated by a light source of the optical capturing system during optical capturing using an incident-light method.

9. A device for producing granular solid particles by the method of claim 1, the device comprising:
at least one first starting substance feed device,
at least one processing device for processing the at least one starting substance, and
at least one optical capturing system which is configured for optically capturing the produced granular solid particles produced emerging from the processing device, and
at least one control device which is configured to control at least one parameter of the production process, the at least one parameter depending on at least one parametric quantity ascertained by the optical capturing system.

10. The device of claim 9, wherein the device has at least one second starting substance feed device for a second starting substance,
wherein the at least one second starting substance feed device has a valve arrangement with a plurality of switchable valves arranged in parallel branches, and
wherein the at least one second starting substance is fed to the processing device with varying quantities depending on the valve actuation of the valves.

11. The device of claim 9, wherein the at least one first starting substance feed device has a valve arrangement with a plurality of switchable valves arranged in parallel branches, and
wherein the at least one first starting substance is fed to the processing device with varying quantities depending on the valve actuation of the valves.

12. The method of claim 1, wherein the method is carried out by executing a computer program on a computer,
wherein the computer program has a program code means.
